(19) United States
(12) Patent Application Publication
(10) Pub. No.: US 2003/0030545 A1
(43) Pub. Date: Feb. 13, 2003

(54) Integrated warning light assembly

(76) Inventors: Donald J. Raczkowski, Northville, MI (US); Jim DeFalco, San Francisco, CA (US); Peter Murphy, Mahwah, NJ (US)

Correspondence Address: STEVEN A. MAYNARD, 300 W. GRAND #412, CHICAGO, IL, 60610, US

(21) Appl. No.: 09/682,251

(22) Filed: Aug. 9, 2001

(51) Int. Cl. B60Q 1/00

(52) U.S. Cl. 340/425.5; 340/815.4; 362/459; 362/542

(57) ABSTRACT

An integrated warning light assembly for an automotive vehicle includes a front half having a parabolic reflecting surface with an orifice therethrough, and a rear half having a light source attached thereto and a plurality of electrical contact terminals molded therein, where the front half is adapted to interchangeably receive the rear half in snap fit fashion and where the light source extends through the orifice.

### BACKGROUND OF INVENTION

This invention relates to automotive vehicle warning lights, and more specifically, to an integrated warning light assembly having a parabolic reflecting surface and a snap fit design.

Automotive vehicle advanced restraint systems incorporate a number of features that supplement standard safety belt systems. One such feature is the system's ability to automatically disable the passenger-side airbag during certain vehicle operating conditions. The operative status of the passenger-side airbag is preferably communicated to the vehicle occupant via an instrument panel warning light.

Conventional warning light assemblies combine a light source disposed within a housing and a window with warning graphics printed thereon, typically referred to as a graphics plane. The graphics plane is positioned intermediate the light source and the vehicle occupant. Typically, the graphics plane is positioned substantially flush with the instrument panel surface, and the housing and light source are hidden from view. When it is desired to communicate information disposed on the graphics plane to the vehicle occupant, current is passed through the light source thereby illuminating the graphics plane.

Conventional warning light assemblies have many sub-components, making the assembly process complex and time consuming. Furthermore, typical assemblies do not allow for sub-component interchangeability. For example, if it is desired to add a light intensity controlling resistor package or change the type of light source, the entire assembly has to be replaced, which is cost ineffective. It would be most beneficial and cost effective to have a permanently attached piece and an interchangeable piece that could be substituted if such changes were desired. It is therefore desired to have a vehicle warning light that is easy to assemble, sub-component integrated, and adapted for sub-component interchangeability.

### SUMMARY OF INVENTION

It is an object of the present invention to provide an integrated warning light assembly that overcomes the disadvantages of the prior art.

The present invention advantageously provides for an automotive vehicle an integrated warning light assembly having a front half with a parabolic reflecting surface and an orifice therethrough, and a rear half with a light source attached thereto and a plurality of electrical contact terminals molded therein, where the front half is adapted to receive the rear half in snap fit fashion and where the light source extends through the orifice.

According to a feature of the present invention, the rear half may be interchanged with other rear halves without having to replace or change the front half, thereby saving on part cost.

### BRIEF DESCRIPTION OF DRAWINGS

These and other objects, features, and advantages of the present invention will become apparent from a reading of the following detailed description with reference to the accompanying drawings, in which:

FIG. 1 is a perspective view of an automotive vehicle integrated warning light assembly according to the present invention;

FIG. 2 is a perspective view of an alternative embodiment of the automotive vehicle integrated warning light assembly according to the present invention;

FIG. 3 is a top, cut-away view of an integrated warning light assembly according to the present invention;

FIG. 4 is an exploded, perspective view of an integrated warning light assembly according to the present invention; and

FIG. 5 is a perspective, cut-away view of an alternative embodiment of a rear half of the integrated warning light assembly according to the present invention.

### DETAILED DESCRIPTION

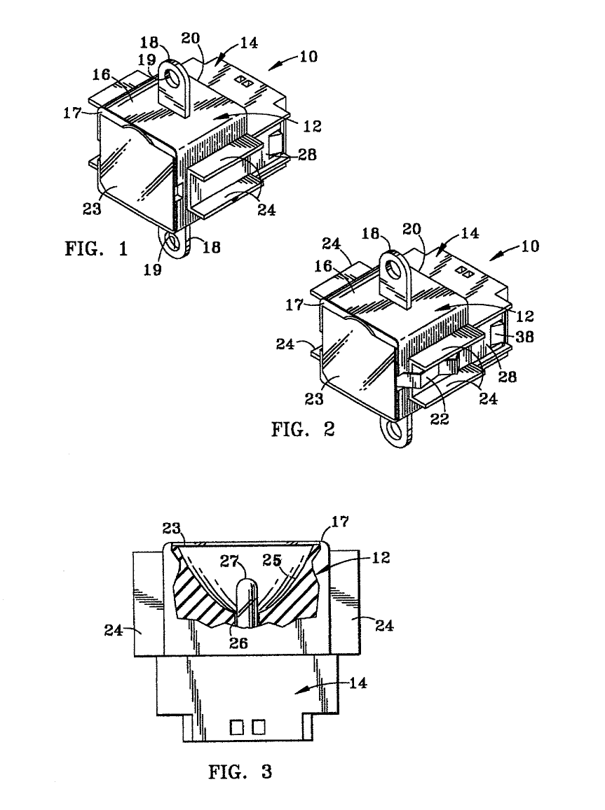

Referring to FIG. 1, an integrated warning light assembly 10 for an automotive vehicle advanced restraint system is illustrated. The warning light assembly 10 is a two piece snap fit design including a front half 12 and a rear half 14. The warning light assembly 10 is adapted to be attached to a vehicle instrument panel. A pair of wing-like mounting tabs 18 project outwardly and substantially perpendicularly from a pair of opposing sidewalls 16. Each mounting tab 18 has a hole 19 therethrough that is adapted to receive a conventional fastener, such as a screw, in order to facilitate mounting the integrated warning light assembly 10 to the instrument panel. In an alternative embodiment, as shown in FIG. 2, a pair of steel spring tabs 22 are attached to a pair of opposing sidewalls 16. Mounting guidewalls 24, projecting perpendicularly from the sidewalls 16, are disposed, in parallel, on either side of each spring tab 22. The spring tabs 22 and corresponding mounting guidewalls 24 cooperate to facilitate mounting the integrated warning light assembly 10 to the instrument panel in snap fit fashion if so desired. The front half 12 is molded with two options for mounting onto the vehicle instrument panel, although other mounting options may be employed without departing from the scope of the present invention.

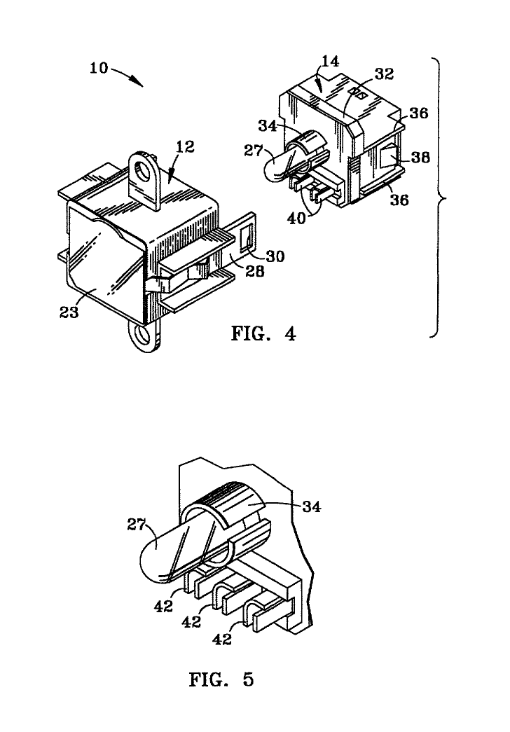

As shown in FIG. 1, the front half 12 has four sidewalls 16 that form a substantially box like shape. Each sidewall 16 has a front edge 17 and a rear edge 20. Projecting inwardly from the sidewalls 16 and rearwardly from the front edges 17 is a parabolic reflector 25, as shown in FIG. 3. The parabolic reflector 25 has a predetermined focal point and an orifice 26 adapted to receive a light source 27 therethrough. The light source 27 may be a conventional incandescent light, a light emitting diode or LED, or the like and is positioned at the focal point of the reflector 25. A translucent graphics plane 23 is disposed on the front edges 17 of the front half 12. The window 23 has graphics disposed thereon that are visible to the vehicle occupant when the light source 27 is illuminated. The graphics for the advanced restraint system may relate to whether the passenger-side airbag has been disabled, or any other desired information without departing from the scope of the present invention. Projecting from a pair of opposing rear edges 20 in coplanar fashion are a pair of mounting flanges 28, each having a notch 30 for attaching the front to the rear half, 12 and 14 respectively, as shown in FIG. 4. The front half 12 is a polymeric, preferably polycarbonate, injection molded unit having a reflective finish added to the reflector 25 after the molding process.

As shown in FIG. 4, the box-like rear half 14 carries the light source 27 and has an electronics package 32 integrated therein. A light socket 34 receives the light source 27, and a pair of integrated terminals 40 service the electronics package 32. As shown in FIG. 5, an alternative embodiment of the rear half 14 has three integrated terminals 42. The third terminal may be used to service a resistor electronics package for controlling light intensity during various exterior ambient light conditions, for example. The rear half 14 further has parallel assembly guidewalls 36 with a ramp 38 therebetween, projecting from opposite sides thereof. The assembly guidewalls 36 and ramps 38 facilitate snap fitting the rear half 14 to the front half 12. More specifically, the rear half 14 is snapped into the front half 12 by aligning each pair of assembly guidewalls 36 of the rear half 14 with a corresponding mounting flange 28 of the front half 12. The assembly guidewalls 36 insure that the notches 30 of the mounting flanges 28 are properly aligned with the ramps 38. The rear half 14 is slid along the mounting flanges 28 via the assembly guidewalls 36, until the mounting flanges 28 engage the ramps 38. Continuing to slide the rear half 14 in such a manner will cause the flanges 28 to flex outwardly until the ramps 38 snap into the notches 30 and the flanges 28 are thereby returned to their pre-flexed position. The rear half 14 is a polymeric, preferably polycarbonate, injection molded structure with integrated terminals 40 molded therein.

The snap fit design not only allows for ease of assembly of the warning light 10, but also for feature interchangeability without having to replace the entire warning light assembly 10. For example, the type of light source or the number of electric terminals may be altered by simply interchanging a rear half 14 with the desired feature into the existing front half 12. This sort of part interchangeability advantageously saves on part cost as the front half 12 is universal regardless of the type of rear half 14. An additional connector (not shown) snaps into the rear half 14 and powers the unit when in the vehicle.

While only certain embodiments of the warning light of the present invention have been described, others may be possible without departing from the scope of the following claims.

1. An integrated warning light assembly for an automotive vehicle comprising:
a front half having a parabolic reflecting surface with an orifice therethrough;
a rear half having a light source attached thereto and a plurality of electrical contact terminals molded therein; and
wherein the front half is adapted to receive the rear half in snap fit fashion with the light source extending through the orifice.

2. The integrated warning light assembly as defined in claim 1, wherein the front half has a plurality of mounting tabs extending therefrom.

3. The integrated warning light assembly as defined in claim 1, wherein the front half has a plurality of mounting guidewalls projecting therefrom.

4. The integrated warning light assembly as defined in claim 3, wherein in at least one spring is attached to the front half and disposed intermediate a pair of mounting guidewalls.

5. The integrated warning light assembly as defined in claim 1, wherein the front half has a translucent graphics plane attached thereto.

6. The integrated warning light assembly as defined in claim 1, wherein the light source is an incandescent light.

7. The integrated warning light assembly as defined in claim 1, wherein the light source is a light emitting diode.

8. An integrated warning light assembly for an automotive vehicle comprising:
a front half having a parabolic reflecting surface with an orifice therethrough;
a rear half having a light source attached thereto and a plurality of electrical contact terminals molded therein; and
wherein the front half is adapted to interchangeably receive the rear half in snap fit fashion with the light source extending through the orifice.

9. The integrated warning light assembly as defined in claim 8, wherein the front half has a plurality of mounting tabs extending therefrom.

10. The integrated warning light assembly as defined in claim 8, wherein the front half has a plurality of mounting guidewalls projecting therefrom.

11. The integrated warning light assembly as defined in claim 10, wherein in at least one spring is attached to the front half and disposed intermediate a pair of mounting guidewalls.

12. The integrated warning light assembly as defined in claim 8, wherein the front half has a translucent graphics plane attached thereto.

13. The integrated warning light assembly as defined in claim 8, wherein the light source is an incandescent light.

14. The integrated warning light assembly as defined in claim 8, wherein the light source is a light emitting diode.
